(19) United States
(12) Patent Application Publication
(10) Pub. No.: US 2002/0103877 A1
(43) Pub. Date: Aug. 1, 2002

(54) Method and system for wireless access to a user's computer

(76) Inventors: Robert Gagnon, Duncan (CA); Emanuel Borsboom, Victoria (CA); Ryan Daniel Peterson, Victoria (CA); Cody DW Jones, Victoria (CA); Will Gordon Brooke, Victoria (CA)

Correspondence Address: MORGAN & FINNEGAN, L.L.P., 345 Park Avenue, New York, NY, 10154, US

(21) Appl. No.: 09/772,132

(22) Filed: Jan. 29, 2001

(51) Int. Cl. G06F 15/16

(52) U.S. Cl. 709/217

(57) ABSTRACT

A method and system for wireless access to a user's desktop computer includes a controller that allows data and applications resident on the user's desktop to be accessed on the wireless device regardless of device type, language, or protocols used. The controller detects what type of wireless device is being used and applies the appropriate formatting through plug-ins that allow the user's wireless device to communicate to the user's desktop through the controller. Data and applications found on the user's desktop are displayed on the user's wireless. In addition, data entries and requests are allowed through the controller from the wireless device to the user's computer.

### FIELD OF THE INVENTION

This invention generally relates to a system and method for providing wireless access to other devices, and more particularly relates to a system and method for providing wireless device users access to their own desktop data and software regardless of the type of wireless device used.

### BACKGROUND

Historically, as communication systems develop, standardization of communication protocols is usually made to allow a larger pool of users. An example of such standardization is that used on the World Wide Web. The Hypertext Transfer Protocol (HTTP) is the set of rules for exchanging files (text, graphic images, sound, video, and other multimedia files) on the web.

However, in the wireless market, many different communication protocols may be used depending on what type of device the user is using for communication. The wireless market is essentially fractured. There are competing standards in devices, languages, transport and interaction levels that are often device and network specific. This competition of standards results in a segmented market place where numerous companies expend a great amount of effort in attempting to have their operating system or language or device become the standard that everyone else uses.

Standardization is desirable from several viewpoints but oftentimes can lead to single company dominance of a technology and the eventual stagnation of innovation. The current market place allows users to choose the device that is familiar to the user. However, it has yet to be offered a system that allows a user to choose any wireless device for communication to the users own applications and data found on the user's desktop or server.

Thus, there remains a need in the art to allow the user to choose a device that meets their lifestyle and personal needs while being able to access their own desktop data and software.

### SUMMARY

The present system and method avoids disadvantages enumerated above as well as other disadvantages. In one aspect, the system and method provides for access by a user's wireless device to a user's desktop applications and data regardless of the type of wireless device used.

Another aspect of the system and method includes a method and system of using a wireless device to access a user's computer. The method includes sending a request from the device, using software to gain access, receiving verification of a connection between a controller and the user's computer, sending the request to the user's computer in the appropriate format, and receiving a response from the user's computer. The system includes a memory device and a processor disposed in communication with the memory device. The processor is configured to send a request from the device, and receive information from the user's computer to the device in a format appropriate to the wireless device.

These aspects and other objects, features, and advantages of the present system and method are described in the following Detailed Description which is to be read in conjunction with the accompanying drawings.

### BRIEF DESCRIPTION OF THE DRAWINGS

FIG. 1 is a schematic block diagram depicting one implementation of the system of the present system and method;

FIG. 2 is a schematic block diagram showing one application of the system of FIG. 1;

FIG. 3 is a schematic flow diagram depicting data access within the system of FIG. 1;

FIG. 4 is a schematic flow diagram depicting illustrating the operation of the system and interaction between the user's wireless device and the system in FIG. 1;

FIG. 5 is a schematic flow diagram illustrating the operation of the system and interaction between a user and the system in FIG. 1;

FIG. 6 is a schematic flow diagram illustrating one implementation of accessing data and applications from a user's desktop by a user's wireless device through the system of FIG. 1;

FIG. 7 is a schematic flow diagram illustrating one implementation of accessing data and applications from a user's desktop by a user's wireless device when the user's desktop is not continuously connected to the system of FIG. 1.

### DETAILED DESCRIPTION

The present invention relates to a system and method for accessing a user's computer through a wireless device. The method and system provides access to the user's computer regardless of the type of wireless device used and regardless of the communication protocols used on the wireless device. Thus, the user is allowed to choose a wireless device that meets their personal lifestyle and needs and be able to gain access to their own desktop data and software. Depending on the implementation, multiple wireless devices can access the user's computer simultaneously as well. The system also interacts with other data management systems and components to provide the wireless user total freedom in choosing what type of wireless device desired to access the user's computer. Once the user's computer is accessed, the user can retrieve data and software that is resident on the user's computer through the use of the wireless device regardless of the communication protocol used by the wireless, and regardless of the type of software or data desired to be accessed.

For purposes of this description, the term “wireless device” refers to any wireless device which includes, but is not limited to, cellular telephones, radio transceivers, wireless lap top or hand held computing devices, wireless personal digital assistants (PDA), or any other type of device that can communicate with a server through wireless technology. The term “computer” as used through out this detailed description refers to a server, a network, mainframe computer, processor, or the like.

The system includes three portions, or logic in its basic architecture. The first portion resides at the user's computer and interfaces with the user's software programs. A program for purposes of this description define a software application that run's on the user's computer. These programs include, but are not limited to e-mail applications, spreadsheet applications, database applications, word processing applications, calendar applications, imaging applications, and analysis applications and the like.

The second portion resides mostly on the central network servers or controller, web servers for example, and is responsible for the presentation logic and interaction with the user's devices, such as cell telephones and PDAs. In one variant, plug-ins are installed into a program that allows data exchange between the application on the user's computer and the controller. A plug-in is defined as an application specific software enhancement that when installed into a program adds features or services or expands the use of the application. Typically, plug-ins are integrated into the software and may operate automatically.

The third portion is a business logic layer that resides on application servers or user's computer and communicates between the other two portions. This third portion performs any interaction with the user computer's data record and related files. Depending on the implementation, this main business logic layer can be implemented as a set of Enterprise JavaBeans (EJB's) that run on the application server. EJB's are an architecture for setting up program component written in the Java programming language that run in the server parts of a computer network that uses the client/server model. EJB's offer the advantage of being able to control change at the server rather than having to update each individual computer with a client whenever a new program component is changed or added. EJB components have the advantage of being reusable in multiple applications.

The principles of the system and method can be understood with reference to two models of operation. The first operation is direct and the second is stored. In the direct model, the user directly controls their desktop applications from their wireless devices. It is all passed through a middle layer running on the central server or controller. When a user performs an action from their device, the logic or portion resident at the controller or central server interprets this action and passes it through the third portion or logic to the first portion or logic residing on the user's computer. This first portion passes the action to the application on the user's computer and returns a response to the second portion or logic residing at the controller or central server via the third portion or logic. The response or information is presented in a formatted style readable to the user's own wireless device. In one variant, the user's computer is always turned on and connected to a communication link, such as the Internet.

In the second model, or stored model, the user computer is not always running or a communication link is not available to the user's computer at a particular time. In this model, a copy of the user's program data is stored in a database on the central server or controller. The user manipulates this data using their device and own software program from their computer that was saved on the central server. The stored data is synchronized with the program's actual data periodically, either automatically by using a timer, or manually when the user authorizes such action.

Depending on the implementation, a software development kit (SDK) can be provided to allow companies to enable their applications to become accessible by wireless devices. In one variant, a Java architecture is used to implement the technology. Such architecture includes but is not limited to Servlets, Java Server Page (JSP), Enterprise JavaBeans (EJB), Java Database Connectivity (JDBC) and the like. EJB's are the same as previously described. JSPs is a technology for controlling the content or appearance of Web pages through use of servlets. Servlets are small software programs on a server that are specified in the Web page and run on the Web server to modify the Web page before it is sent to the user who requested it. JDBC is an application program interface specification for connecting programs written in Java to the data in a database. The application interface allows encoding access request statements in structured query language that are then passed to the program that manages the database.

Some of the features of the present system and method include providing the ability to obtain wireless access to existing software programs at the user's own desk top computer. This access is despite the type of communication protocol or wireless device used by the user. For example, WAP(Wireless Application Protocol) is a specification for a set of communication protocol to standardize the way that wireless devices, such as cellular telephones and radio transceivers, can be used for internet access. Such access includes e-mail, the World Wide Web, newsgroups, and Internet Relay Chat. While Internet access has been possible in the past, different manufacturers are using different technologies for this wireless access. For example, WAP was developed by four companies. In Japan, a service called i-Mode is available for wireless access. i-Mode is a packet based service for mobile telephones that unlike WAP uses a simplified version of hypertext markup language (HTML). WAP uses a language called Wireless Markup Language (WML) which currently is incompatible with i-Mode. Both systems are widely used throughout the world. As of early 2000, i-Mode had an estimated 5.6 million users. Thus, despite this diversity, the present system and method allows any communication protocol to obtain wireless access to a user's own desktop applications.

Depending on the implementation, the present system and method utilizes a browser-based software application accessed through the Internet, which enables companies to obtain wireless access their data easily and economically without giving up their present programs. Employees are allowed to log-on anywhere: work, home, remote offices and even airports and hotels to gain wireless access through their own personal wireless devices to their desktop computers.

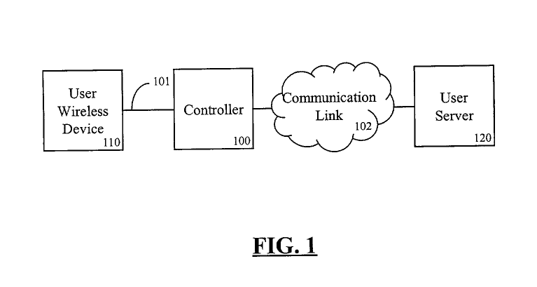

Referring to the drawings, shown in FIG. 1 is a schematic block diagram representing an example system constructed to illustrate and operate according to the principles of the present system and method. Shown in the figure is a controller 100 which schematically represents a network, mainframe computer, processor, in communication with or including an image storage/retrieval system, or a database submitted as described herein. When specifically operating in accordance with the principles of the present system and method, the controller 100 operates as a receiver, translator, processor, and distributor of information related to the user's data and software applications residing at the user's computer.

The controller 100 responds to requests by identifying the appropriate device and associated communication protocol. This protocol listener receives the request from the device, performs tasks such as detecting what type o device is requesting access, what browser is running, and creating a session for example. In essence, the controller can sniffs out particular properties so that the eventual response is tailored to the device requesting the access to the user's computer. The request is passed to the appropriate service type presentation plug-in for the service type, device type, browser type and the like. Service type for the purposes of this description means a particular service provided by an application. For example, service types include, but are not limited to, contact information(such as e-mails), scheduling (calendars), word processing, data processing(spread sheets), imaging(computer aided drafting), and the like.

The service type presentation plug-in is responsible for interaction with the user. Depending on the implementation, there can be more than one service type presentation plug-in for the same service type that is customized for each type of device and browser. The service type presentation plug-in makes requests to the service type logic plug-in and is preferably application specific. The advantage is to provide the richest possible experience for a particular device. Thus, a user that uses a high functioning web browser on their computer has a richer experience than a user with the lower functioning cell telephone.

The service type logic plug-ins performs the actions that the user requested through the presentation plug-in. The same logic can be shared among many different presentation front-ends. For a particular service type, separate plug-ins both the direct and stored models can be used. In the direct model, the logic plug-in passes the action to logic residing at the user's computer which takes care of passing to logic that will return the result. The result is in turn sent back to the presentation plug-in. In the stored model, the action is performed on the stored version of the data.

Results are provided for display on a user's wireless device 110. Wireless device 110 refers to any wireless device including, but not limited to, cellular telephones, radio transceivers, PDA's lap top computers and the like. Depending on the implementation, the controller 100 receives information from a user's desktop computer and, depending upon the item, converts the item to an image file, a textual file or some other file suitable for storage and later for retrieval and display using known techniques.

The block 110 depicts a user's wireless device that utilizes the controller 100. As previously stated, the controller 100 contains the logic that allows the user's wireless device to communicate with the user's desk top computer. In one variant, the user may also be authorized third parties, which have been granted access to the particular plug-in enhanced software. The user may also be one of a multitude of entities using the controller.

The user device 110 is connected to the controller 100 by a communication link 101. Depending on the implementation, link 101 can be a data link or communication link such as the Internet. Such data link can alternatively be, but is not limited to, an electronic data link, optical fiber connection, wireless data connection or any other known connection used for data transfer, for example, over the Internet. Depending upon the implementation, link 101 can operate in one or more modes of transmission. For example, such modes include radio frequency transmissions, optical transmission, microwave transmission, digital or analog transmission, or other known data transmission mode.

A user server 120 is also connected to controller 100 by a communication link 102. The user server 120 can be any entity or group of entities, for example a user's desktop computer, a LAN based system, and the like. Information can be received by the user device 110 through communication link 102 and through the controller 100. Depending on the implementation, link 101 can be a data link or communication link such as the Internet. Such data link can alternatively be, but is not limited to, an electronic data link, optical fiber connection, wireless data connection or any other known connection used for data transfer, for example, over the Internet. Depending upon the implementation, link 102 can operate in one or more modes of transmission. For example, such modes include those similarly discussed with reference to link 101, but need not bear any relationship to link 101. Thus, link 101 and link 102 may be the same or different types of communication links depending on the implementation.

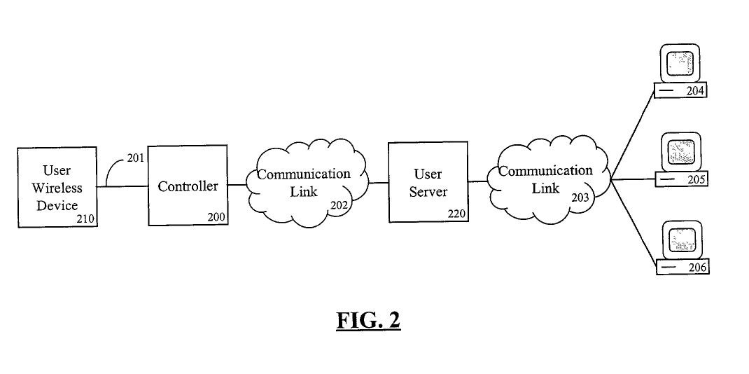

FIG. 2 illustrates a system and method for gaining wireless access to a network of computers. Shown is a user wireless device 210 which is described similarly to wireless device 110. A communication link 201 connects the device to a controller 200. Communication link 201 has a similar description as communication links 101 and 102, but need not bear any other relationship. Thus, the communication links may be the same or different types. Controller 200 houses the logic required to give the wireless device access to user server 220. A communication link 202 connects controller 200 to user server 220. Again, communication link 202 is a previously described for links 101,102, and 201, but need not bear any other relationship with these links.

User server 220 may be a computer, processor, server, network or the like. User server 220 is connected by communication link 203 to a plurality of user computers 204, 205 and 206 respectively. Again, communication link 203 is similar to communication link 202, but need not bear any other relationship. Additionally, communication link 203 may also include wire access such as through a network. In one implementation, user server 220 is a LAN server and connected to a network of computers 204, 205, 206 through link 203. Thus a user's wireless device may gain access, with authorization, to data and software residing at a plurality of user's desk top computers. Additionally, user wireless device 210 can gain access to data and software residing at server 220. Again, the advantage is that the user is able to utilize personal data and software through there own personalized wireless device, such as a cellular telephone, regardless of the communication protocols used and obtain the highest resolution possible in displaying the data or software application by the controller translating the results in a format appropriate for the wireless device used.

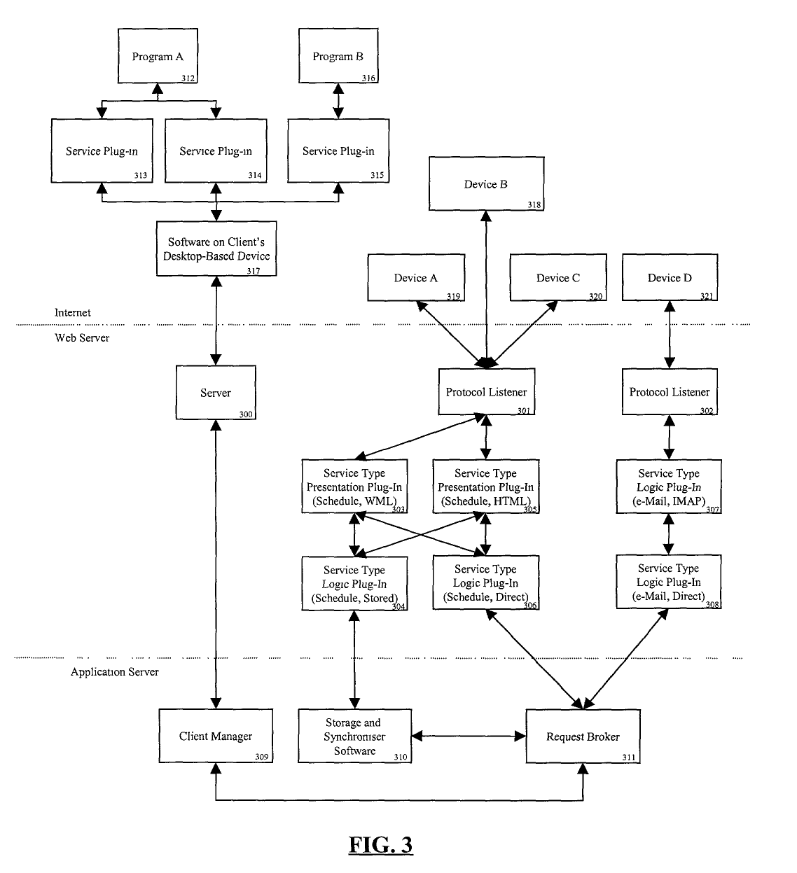

The operation of an example system and method employing the principles of described above is schematically illustrated by FIG. 3 and described below as follows. FIG. 3 illustrates one example schematic flow diagram depicting the operation relative to FIG. 1. A program A 312 and program B 316 illustrate various applications residing at the user's computer. These applications include for example, e-mail applications, or data acquisition applications. The applications 312 and 316 in one implementation are specifically connected to service plug-ins 313, 314, and 315 respectively. As shown, each application may have one or more service plug-ins associated with the user computer's application. In one variant, the plug-ins are specifically tailored to the user's programs to assist in the wireless accessing. These service-type logic plug-ins are in communication with software based on the user's desktop computer. This software is used to communicate with server 300. Depending on the implementation, this server can reside on a web based server. It is this server that the user's computer connects to and passes requests/responses to/from the user's wireless device and user's desktop computer.

Server 300 is in communication with a client manager 309. Client manager 309 resides on an application server and keeps track of which users are connected and each user's authentication information. Authentication information includes, but is not limited to, date of birth, pass word, PIN, digital certificate, governmental issued information and the like. Client-manager 309 is in communication with request broker 311. Request broker 311 resides on an application server. It provides routing requests and directs responses to the correct user. The request broker 311 is in communication with storage and synchronizer software 310. Software 310 resides on an application server, It provides facilities for storing user data and synchronizing stored data with the user's applications.

As illustrated multiple wireless devices may access the user's computer shown by device A 319, device B318 and device C 320 accessing the same user computer. Devices, 318, 319, and 320 need not bear any relationship between each other. For example, device 318 in one implementation can be a cellular telephone, device 319 can be a PDA and device C can be a computer. Solitary access is also provided as illustrated by device D 321.

When wireless access is desired through these devices, the wireless devices are in communication with protocol listeners 301 and 302 respectively. Again, only one protocol listener is required independent of the number of devices seeking access. Protocol listeners resides, preferably, on a web server, but need not do so within the operating principles of the system and method. The listener accepts connections from users wireless devices, and determines the type of device used as previously described. Listener 301 and listener 302 are in communication with service type logic plug-ins 303, 305, and 307, respectively. A listener may or may not be in communication with more than one service type presentation plug-in, depending on the implementation. In addition, the listener may or may not be directly connected to a service type logic plug-in. Presentation plug-ins 303, 305 and 307 are in communication, in this illustration, with service type logic plug-in 304, 306 and 308, respectively. Service type presentation plug-ins resides on the web server and provides presentation logic for a Service type. Service type logic plug-in resides on the web server and provides application logic for a Service type.

In the direct model, the service type logic plug-in is in communication with the request broker to gain access to the user's desktop computer. In the stored model, the plug-in is in communication with the storage software 310 for later synchronization with the user's computer when communication is achieved.

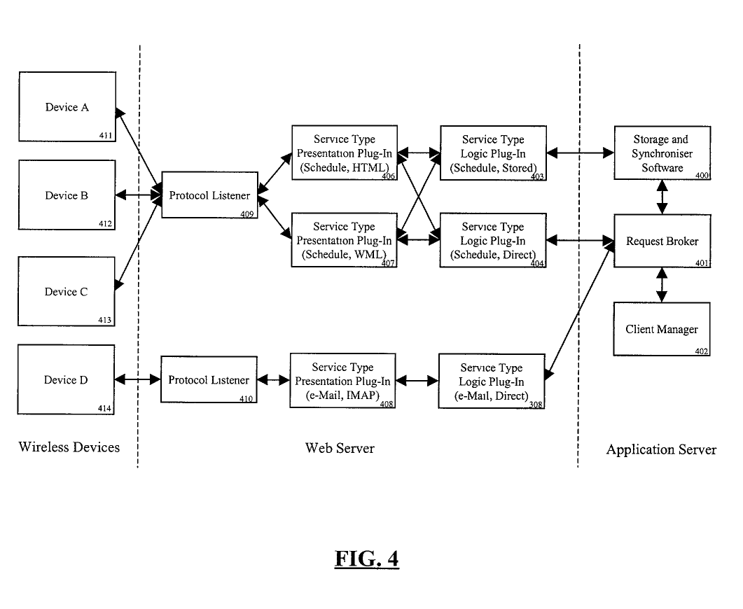

Depending on the implementation, the protocol listener may interact with one or several devices. Illustrated in FIG. 4, device A 411, device B 412, and device C 413 all interact with listener 409. However, in another variant device D 414 can interact solitarily with listener 410. This arrangement allows the maximum flexibility needed to answer requests in various volumes of communication traffic.

Listeners 409 and 410 interact with plug-ins 406, 407, and 408 as indicated in FIG. 4. Again, the listeners may interact with one or more plug-ins to provide the flexibility necessary to deal with various flows or volumes of communication requests. Similarly, the plug-ins 406, 407 and 408 interact with plug-ins 403, 404, and 405 as previously described and for similar advantages.

Again, depending on the model used, direct or stored, the plug-ins interact with storage software 400 if utilizing the stored model as previously described. If using the direct model, the service type logic plug-ins can interact with the request broker 401 and client manager 402 for access to the user's computer or decide to use the stored model and be routed to storage software 400.

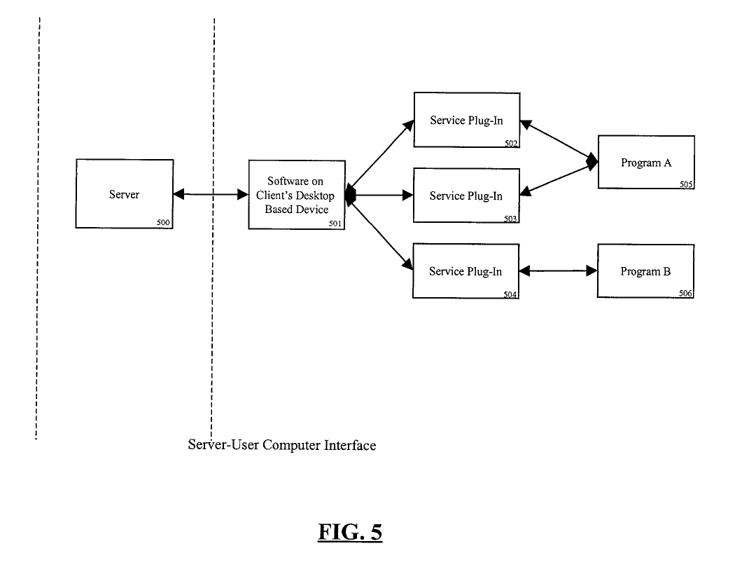

FIG. 5 includes server 500 which interact with software 501 based on the client's or users desk top computer. As previously, discussed, desktop computer refers to any computer, network, processor server or the like. Software 501 manages the plug-ins 502, 503, and 504, which depending on the implementation are designed specifically for each user program or application. Again, a program may have one or more than one plug-ins associated with it to assist in the wireless communication. This is illustrated with program A 505 interacting with plug-ins 502 and 503. In addition, program B is shown interacting only with plug-in 504. Software 502 manages the communication back to server 500 to be sent further to the user's wireless devices for further commands/display.

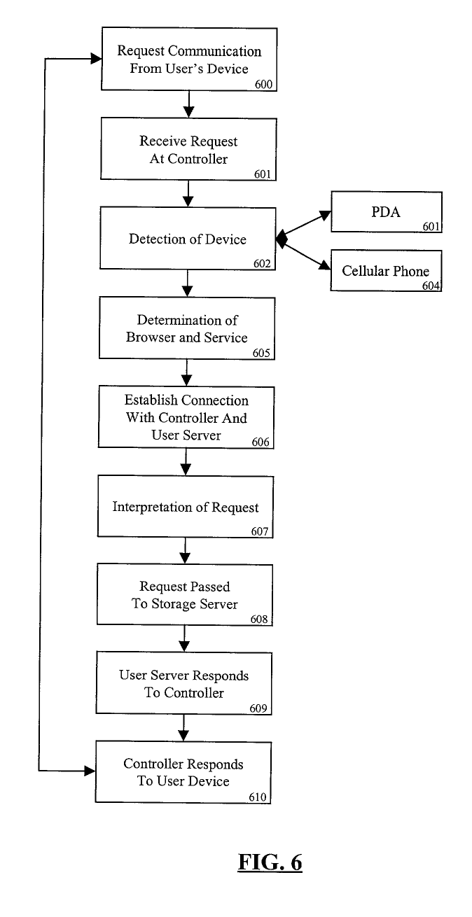

FIG. 6 illustrates one implementation of a direct model. Block 6000 depicts sending a request communication from a user's wireless device. This communication 600 is received at the controller as shown in block 601. Determination of device type and other properties as previously described are done in block 602. Again these device can be any type of wireless device using any type of communication protocol such as used in PDA 601 and cellular telephone 604. Communications can be WAP or i-Mode based.

Depending of the implementation, the user “picks” either the stored or direct model before data is accessed or manipulated. For example, when the user has a permanent connection, the direct model is used. That is, when a request is made, it is passed through to the user's desktop application and the request is fulfilled and returned to the user. If the user's connection is down or has been terminated, the user will not be able to access the user's data or save data to their desktops.

In another variant, when the user does not have a direct connection, the stored model is used. In the stored model, a copy of the user's data is stored on the server, a logic plug-in manipulates and retrieves the data and periodic synchronization occurs to ensure that server-stored data is consistent with the user's desktop data. When a request is made, it is executed using the server copy of the user's data. Direct access to the user's desktop is not an option.

Determination of browser and service type is accomplished in block 605. Again service type refers to the type of application the user is attempting to use on the desk top computer. Block 606 indicates establishment of connection with the controller and user server or desktop computer. The user may or may not receive notification of the establishment of the communication link depending on the implementation. Additionally, the user may or may not be notified when access is attempted, either successful or unsuccessful, with the user server in block 606. Interpretation of the request commences in block 607. Logic is used via plug-ins for appropriate presentation and service type manipulations. The request is passed to a storage server 608 if no communication link is established in block 606. If a connection is established, the user server responds to the controller in block 609. Block 610 depicts the controller then transmitting the response to the user's wireless device for further requests from the user.

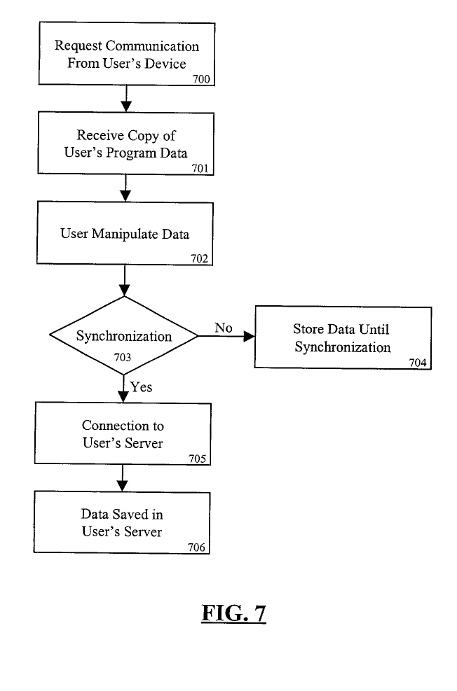

FIG. 7 illustrates an exemplary storage model. The request is transmitted by the user's wireless device in block 700. In block 701, the user's wireless device receives a copy of the user's program data since no communication with the user server is available. The user can manipulate the data in block 702, and then synchronization of the manipulated data either occurs or does not occur as shown in decision block 703. If no as shown in block 704, then the data is stored until synchronization does occur. If yes as shown in block 705 then connection to the user's server is established in block 705. The data is then saved in the user's server for future use as depicted in block 706.

It should be understood that the above description is only representative of illustrative examples of various embodiments and implementations. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Depending on the implementation, it is further recognized that the order or sequence of tasks illustrated in the figures are merely intended to be exemplary of the concepts defined herein. It is understood that the tasks shown in the figures can be in any order to achieve the desired end result.

Alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent.

What is claimed is:

1. A method for providing access through a wireless device to a user's computer or network comprising:
receiving a request from the device;
detecting the type of device performing the request;
determining the software being used for access;
determining the network service being used by the wireless device;
establishing a connection between a controller and the user's computer;
interpreting the request from the device;
sending the request to the user's computer in the appropriate format;
receiving a response from the user's computer;
translating the response into the appropriate format for the device; and
sending information received from the user's computer to the device in the appropriate format.

2. The method of claim 1 wherein the information includes data and software application resident at the user's computer.

3. A method for providing access through a wireless device to a user's computer comprising:
sending user verification information in response to a log-on request from a wireless device;
authenticating the wireless user to permit access to a controller;
detecting format parameters of the wireless device
sending information to the wireless device from the user's computer in an appropriate format.

4. The method of claim 3 further including establishing a connection between the controller and the user's computer.

5. The method of claim 3 further including storing information for access by the user's wireless device when connection to the user's computer is not established.

6. The method of claim 5 further including transmitting manipulated information to the user's computer when a connection to the user's computer is established.

7. The method of claim 5 further including storing manipulated information until a connection to the user's computer is established.

8. A method for providing access through a wireless device to a user's computer comprising:
receiving a request from the device;
sending the request to the user's computer in an appropriate format for the users computer;
sending information received from the user's computer to the device in an appropriate format for the wireless device.

9. The method of claim 8 further including storing data entered through the wireless device when a communication link is unavailable to the user's computer.

10. The method of claim 8 wherein the request receiving further includes detecting information concerning the type of wireless device being used.

11. The method of claim 10 further including using the device detection information to authorize access to the user's computer.

12. The method of claim 8 wherein the request receiving further includes receiving requests in any language.

13. The method of claim 8 wherein the request receiving further includes receiving request from wireless devices using any communication protocol.

14. The method of claim 8 further including maintaining a secure environment for data entry and data collection from the user's computer.

15. A method for providing access through a wireless device to a user's computer comprising:
receiving a request from the device;
detecting the type of device performing the request;
applying appropriate logic required to transmit the request to the user's computer; and
sending information received from the user's computer to the device in a format appropriate to the wireless device.

16. The method of claim 15 further including applying appropriate logic to the information received from the user's computer for further communication to the wireless device.

17. The method of claim 15 further including encrypting transmissions between the wireless device and the user's computer.

18. The method of claim 15 further including notifying a user when access to the user's computer is attempted.

19. The method of claim 15 further including recording time and date information of access attempt to the user's computer.

20. The method of claim 15 wherein the application of logic further includes using plug-ins.

21. The method of claim 20 wherein the plug-ins are specific to the type of application which access is desired from the user's computer by the wireless device.

22. A computerized system for providing access through a wireless device to a user's computer, comprising:
a memory device; and
a processor disposed in communication with the memory device, the processor configured to: send user verification information in response to a log-on request from a wireless device, authenticate the wireless device to permit access to a controller, detect format parameters of the wireless device, and send information to the wireless device from the user's computer in an appropriate format.

23. A computerized system for providing access through a wireless device to a user's computer, comprising:
a memory device; and
a processor disposed in communication with the memory device, the processor configured to
receive a request from the device;
send the request to the user's computer in an appropriate format for the users computer;
send information received from the user's computer to the device in an appropriate format for the wireless device.

24. A computerized system for providing access through a wireless device to a user's computer, comprising:
a memory device; and
a processor disposed in communication with the memory device, the processor configured to:
receive a request from the device;
detect the type of device performing the request;
apply appropriate logic required to transmit the request to the user's computer; and
send information received from the user's computer to the device in a format appropriate to the wireless device.

25. A computerized system for providing access through a wireless device to a user's computer, comprising:
means for sending user verification information in response to a log-on request from a wireless device,
means for authenticating the wireless device to permit access to a controller,
means for detecting format parameters of the wireless device, and
means for sending information to the wireless device from the user's computer in an appropriate format.

26. A computerized system for providing access through a wireless device to a user's computer, comprising:
means for receiving a request from the device;
means for sending the request to the user's computer in an appropriate format for the users computer; and
means for sending information received from the user's computer to the device in an appropriate format for the wireless device.

27. A computerized system for providing access through a wireless device to a user's computer, comprising:
means for receiving a request from the device;
means for detecting the type of device performing the request;
means for applying appropriate logic required to transmit the request to the user's computer; and
means for sending information received from the user's computer to the device in a format appropriate to the wireless device.

28. A computer readable medium comprising:
code for receiving a request from the device;
code for sending the request to the user's computer in an appropriate format for the users computer; and
code for sending information received from the user's computer to the device in an appropriate format for the wireless device.

29. The computer readable medium of claim 28 further including code for applying appropriate logic required to transmit the request to the user's computer.

30. The computer readable medium of claim 28 further including code for maintaining secure communication between the wireless device and the user's computer.

31. A method of using a wireless device to access a user's computer comprising:
sending a request from the device;
using software to gain access;
receiving verification of a connection between a controller and the user's computer;
sending the request to the user's computer in the appropriate format; and
receiving a response from the user's computer.

32. The method of claim 31 further including receiving information concerning data and at least one software application resident at the user's computer.

33. A method of using a wireless device to access a remote user's computer comprising:
receiving user verification information in response to a log-on request from the wireless device;
sending authentication information to permit access to a controller; and
receiving information at the wireless device from the remote user's computer in an appropriate format that is readable to the wireless device.

34. The method of claim 33 further including receiving verification that a connection is established between the controller and the user's computer.

35. The method of claim 33 further including using stored information from the remote user's computer resident at the controller when connection to the user's computer is not established.

36. The method of claim 35 further including sending a request to store manipulated information until a connection to the user's computer is established.

37. A method of using a wireless device to access a remote user's computer comprising:
sending a request from the device for connection to a controller;
sending a request to the remote user's computer which is translated in an appropriate format by the controller;
receiving information from the remote user's computer to the device in an appropriate format readable to the wireless device.

38. The method of claim 37 further including executing commands from the wireless device from software resident at the remote user's computer.

39. The method of claim 37 wherein the receiving information further includes data and at least one software application resident at the remote user's computer.

40. The method of claim 39 further including manipulating the data on the wireless device.

41. The method of claim 40 wherein the manipulated data is sent back to the user's computer for storage.

42. The method of claim 37 wherein the requests sending further includes sending requests from wireless devices using any communication protocol.

43. The method of claim 37 further including sending to the user's computer and receiving data from the user's computer in a secure environment.

44. A method of using a wireless device to access a remote user's computer comprising:
sending a request from the device; and
receiving information from the remote user's computer to the wireless device in a format appropriate to the wireless device.

45. The method of claim 44 further including contacting the user's computer from more than one wireless device.

46. The method of claim 44 further including sending encrypted transmissions between the wireless device and the user's computer.

47. The method of claim 44 further including receiving notification when access to the user's computer is attempted.

48. The method of claim 44 further including receiving time and date information of access attempt to the user's computer.

49. The method of claim 44 further including using plug-ins to communicate with the user's computer.

50. The method of claim 49 wherein the plug-ins are specific to the type of application which access is desired from the user's computer by the wireless device.

51. A computerized system for using a wireless device to access a user's computer comprising:
a memory device; and
a processor disposed in communication with the memory device, the processor configured to:
receive user verification information in response to a log-on request from a wireless device, send authentication information to permit access to a controller, and receive information from the user's computer in an appropriate format readable to the wireless device.

52. A computerized system using a wireless device to access a user's computer comprising:
a memory device; and
a processor disposed in communication with the memory device, the processor configured to
send a request to the user's computer in an appropriate format for the users computer;
receive information from the user's computer in an appropriate format for the wireless device.

53. A computerized system using a wireless device to access a user's computer comprising:
a memory device; and
a processor disposed in communication with the memory device, the processor configured to:
send a request from the device;
receive information from the user's computer in a format appropriate to the wireless device; and
transmit data for storage on the user's computer.

54. A computerized system using a wireless device to access a user's computer comprising:
means for receiving user verification information in response to a log-on request from a wireless device,
means for sending authentication information from the wireless device to permit access to a controller, and
means for receiving information from the user's computer in an appropriate format.

55. A computerized system using a wireless device to access a user's computer comprising:
means for sending a request from the device; and
means for receiving information from the user's computer to the device in an appropriate format for the wireless device.

56. A computerized system using a wireless device to access a user's computer comprising:
means for sending a request from the device;
means for receiving information from the user's computer to the device in a format appropriate to the wireless device; and
means for storing user manipulated information on the user's computer through the wireless device.

57. A computer readable medium for using a wireless device to access a user's computer comprising:
code for sending a request from the device; and
code for receiving information from the user's computer in an appropriate format for the wireless device.

58. The computer readable medium of claim 57 further including code for storing user manipulated information on the user's computer through the wireless device.

59. The computer readable medium of claim 57 further including code for maintaining secure communication between the wireless device and the user's computer.

60. A computer readable medium for using a wireless device to access a remote user's computer comprising:
code for sending a request from the device;
code for executing software commands resident at the remote user's computer; and
code for receiving information from the user's computer in an appropriate format for the wireless device.
